(19) United States
(12) Patent Application Publication
(10) Pub. No.: US 2011/0134756 A1
(43) Pub. Date: Jun. 9, 2011

(54) OPERATING METHOD OF SESOR NETWORK AND NETWORK NODE PROVIDING ROUTING MECHANISM SUPPORTING REAL-TIME TRANSMISSION OF PRIOR INFORMATION

(75) Inventors: Hyeon PARK, Daejeon (KR); Sang Joon Park, Daejeon (KR); Cheol Sig Pyo, Daejeon (KR)

(73) Assignee: Electronics and Telecommunications Research Institute, Daejeon (KR)

(21) Appl. No.: 12/824,602

(22) Filed: Jun. 28, 2010

(30) Foreign Application Priority Data
Dec. 7, 2009 (KR) 10-2009-0120612

(51) Int. Cl. H04L 12/26

(52) U.S. Cl. 370/238

(57) ABSTRACT

Provided is an operating method of sensor network. The operating method detects upper network nodes of a specific network node. The operating method detects link costs between the specific network node and the detected upper network nodes, respectively. The operating method detects a transmission and reception rate for the detected upper network nodes of the specific network node. The operating method selects one of the detected upper network nodes as a parent node of the specific network node, based on the detected link costs and the detected transmission and reception rate.

### CROSS-REFERENCE TO RELATED APPLICATIONS

This U.S. non-provisional patent application claims priority under 35 U.S.C. §119 of Korean Patent Application No. 10-2009-0120612, filed on Dec. 7, 2009, the entire contents of which are hereby incorporated by reference.

### BACKGROUND OF THE INVENTION

The present invention disclosed herein relates to a network, and more particularly, to an operating method of sensor network and network node providing routing mechanism supporting real-time transmission of prior information.

A sensor network is configured with a plurality of sensor nodes and a sink node. Each of the sensor nodes includes a sensor and transmits a sensing result to the sink node through a channel. A control node processes sensing results that are collected from the sensor nodes.

The sensor network detects in real time the information of areas in which the sensor nodes are disposed. For example, the sensor network may be applied as a means for detecting the border, a means for detecting parking states, a means for detecting weather and a means for detecting accidents and disasters.

The plurality of sensor nodes and the control node communicate through a wireless channel. Accordingly, the communication ranges of the sensor nodes and control node are limited. Sensor nodes, which are disposed without the communication range from the control node, communicate with the control node through the sensor nodes. That is, the sensor nodes perform multi-hop communication.

When multi-hop communication is performed, packet traffic may be concentrated on a specific sensor node. When the packet traffic is concentrated on the specific sensor node, communication speed in the specific sensor node is reduced. This circumstance is called congestion.

A portion of information that is collected through the sensor network requires real-time transmission. For example, a packet for indicating the invasion of an enemy in a border detection network, a packet for indicating disaster such as typhoon or flood in a weather detection network and a packet for indicating the occurrence of a traffic accident in an accident detection network may require real-time transmission.

### SUMMARY OF THE INVENTION

The present invention provides a sensor network for providing routing mechanism supporting real-time transmission of prior information and a network node operating method thereof.

Embodiments of the present invention provide an operating method of sensor network including: detecting upper network nodes of a specific network node; detecting link costs between the specific network node and the detected upper network nodes, respectively; detecting a transmission and reception rate for the detected upper network nodes of the specific network node; and selecting one of the detected upper network nodes as a parent node of the specific network node, based on the detected link costs and the detected transmission and reception rate.

In some embodiments, the selecting of one of the detected upper network nodes may include calculating weighted link costs from the detected link costs by using the detected transmission and reception rate as a weight value, wherein one of the detected upper network nodes is selected as the parent node of the specific network node, based on the weighted link costs.

In other embodiments, the operating method may further include transmitting link costs between the detected upper network nodes and a sink node to the specific network node, wherein one of the detected upper network nodes is selected as the parent node of the specific network node, based on the weighted link costs, the detected transmission and reception rate and the transmitted link costs.

In still other embodiments, the transmitting of link costs may include transmitting weighted link costs between the detected upper network nodes and the sink node to the specific network node.

In even other embodiments, a network node having a highest weighted link cost among the detected upper network nodes may be selected as a parent node.

In yet other embodiments, the operating method may further include detecting a transmission packet amount of the selected parent node when a transmission packet exists in the specific network node, wherein at least one of transmission packets of the parent node is deleted when the detected transmission packet amount is less than a first reference amount.

In further embodiments, the detecting of a transmission packet amount may include detecting a transmission packet amount of the specific network node and a transmission packet amount of the selected parent node, wherein at least one of the transmission packets of the parent node is deleted when the transmission packet amount of the specific network node and the transmission packet amount of the selected parent node are greater than the first reference amount.

In still further embodiments, the at least one deleted transmission packet may include a low rank transmission packet or a transmission packet in which guaranteed delay is exceeded.

In even further embodiments, the operating method may further include detecting a transmission packet amount of the selected parent node when a transmission packet exists in the selected parent node, wherein a transmission period of a control packet, which is transmitted from the selected parent node, is controlled based on a comparison result of the detected transmission packet amount and a second reference amount.

In yet further embodiments, the transmission period of the control packet may increase when the detected packet amount is more than the second reference amount.

In much further embodiments, the transmission period of the control packet may decrease when the detected packet amount is less than the second reference amount.

In other embodiments of the present invention, an operating method of network node of sensor network includes: detecting upper network nodes; detecting link costs for the detected upper network nodes, respectively; detecting a transmission and reception rate for the detected upper network nodes; and selecting one of the detected upper network nodes as a parent node, based on the detected link costs and the detected transmission and reception rate.

In some embodiments, the selecting of one of the detected upper network nodes may include: calculating weighted link costs from the detected link costs by using the detected transmission and reception rate as a weight value; and selecting one of the detected upper network nodes as a parent node, based on the weighted link costs.

In other embodiments, the selected parent node may be updated when the weighted link costs of the detected upper network nodes are changed.

In still other embodiments, the network node may include a first layer controlling communication between network nodes, and a second layer supporting management of a network path through which a packet is transmitted, wherein the first layer may include a queue storing a transmission packet, and the operating method may further include directly transferring a transmission packet to a queue of the first layer when the transmission packet is generated.

In even other embodiments, the transmission packet may be generated when relay transmission of a packet is performed.

In yet other embodiments, the operating method may further include determining a priority of a packet which is transferred to the queue, when the transmission packet is generated, and determining a transmission order of the packet which is transferred to the queue, based on the determined priority.

In further embodiments, the operating method may further include determining the transmission packet amount when a transmission packet exists, and increasing a transmission period of a control packet, when the determined transmission packet amount is greater than a reference amount.

In still further embodiments, the operating method may further include determining the transmission packet amount when a transmission packet exists, and decreasing a transmission period of a control packet, when the determined transmission packet amount is less than a reference amount.

In even further embodiments, the operating method may further include combining at least two transmission packets into one packet to transmit the combined packet, when transmitting a packet.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram illustrating a sensor network according to an embodiment of the present invention;

FIG. 2 is a block diagram illustrating the channel connection state of the sensor network in FIG. 1;

FIG. 3 is a block diagram illustrating an embodiment of the present invention in which the network environment of the sensor network in FIG. 1 has been changed;

FIG. 4 is a flow chart for describing an operating method of the sensor network which has been described above with reference to FIGS. 1 through 3;

FIG. 5 is a flow chart for describing a parent node updating operation of the sensor network which has been described above with reference to FIGS. 1 through 3;

FIG. 6 is a block diagram illustrating the first and third sensor nodes of the sensor network in FIG. 1;

FIG. 7 is a flow chart for describing a packet amount managing operation of the first and third sensor nodes in FIG. 6;

FIG. 8 is a flow chart for describing a control packet managing operation of the first and third sensor nodes in FIG. 6;

FIG. 9 is a table showing packets which are exchanged between the parent node and child node of the sensor network in FIG. 1;

FIG. 10 is a block diagram illustrating a third sensor node in FIG. 1;

FIG. 11 is a diagram illustrating an embodiment of a sensor system which includes the sensor network in FIG. 1; and

FIG. 12 is a diagram illustrating another embodiment of a sensor system including the sensor network in FIG. 1.

### DETAILED DESCRIPTION OF PREFERRED EMBODIMENTS

Hereinafter, preferred embodiments of the present invention will be described with reference to the accompanying drawings to fully explain the present invention in such a manner that it may easily be carried out by a person with ordinary skill in the art to which the present invention pertains. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout. Similar reference numerals refer to similar elements throughout.

Hereinafter, it will be described about an exemplary embodiment of the present invention in conjunction with the accompanying drawings.

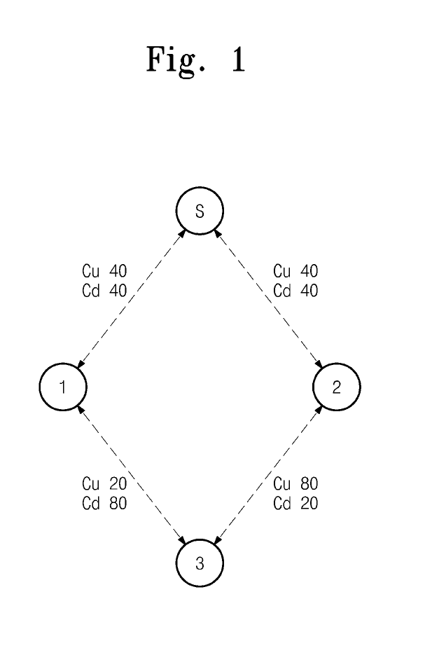

FIG. 1 is a block diagram illustrating a sensor network 10 according to an embodiment of the present invention.

Referring to FIG. 1, a sensor network 10 according to an embodiment of the present invention includes a sink node S, and first to third sensor nodes 1 to 3. Like the sink node S and the first to third sensor nodes 1 to 3, each of nodes configuring the sensor network 10 is called a network node. In FIG. 1, the sink node S and the first to third sensor nodes 1 to 3 are illustrated. However, the sensor network 10 is not limited to be configured with the sink node S and the first to third sensor nodes 1 to 3.

Each of the sensor nodes 1 to 3 includes a sensor. Each of the sensor nodes 1 to 3 includes at least one of sensors that may recognize ambient environments such as motion sensors, temperature sensors, gravity sensors, pressure sensors and photo sensors. Each of the sensor nodes 1 to 3 includes communication equipment. For example, each of the sensor nodes 1 to 3 includes wireless communication equipment. The sensor nodes 1 to 3 transmit sensing results to the sink node S through communication equipment. Exemplarily, the first to third sensor nodes 1 to 3 transmit sensing results to the sink node S through multi-hop communication.

The sink node S processes sensing results that are collected from the first to third sensor nodes 1 to 3. For example, the sink node S may be connected to a control center (or server) for managing a sensor network. For example, the sink node S may be connected to an Internet Protocol (IP) network through a gateway.

Exemplarily, communication channels that may be established between the sink node S and the first to third sensor nodes 1 to 3 are illustrated in FIG. 1. The third sensor node 3 may communicate with the first and second sensor nodes 1 and 2. That is, the first and second sensor nodes 1 and 2 may perform one-hop communication with the sink node S, and the third sensor node 3 may perform multi-hop communication, more particularly, two-hop communication with the sink node S through the first and second sensor nodes 1 and 2.

Hereinafter, routing depth will be defined. The routing depth is set based on the number of hops between a specific network node and the sink node S. The routing depth of the sink node S is set to ‘0’. The routing depths of network nodes, i.e. the first and second sensor nodes 1 and 2, which perform one-hop communication with the sink node S are set to ‘1’. The routing depth of a network node, i.e. the third sensor node 3, which perform two-hop communication with the sink node S are set to ‘2’. Likewise, the routing depths of network nodes that perform n-hop communication with the sink node S are set to ‘n’. Exemplarily, a network node having the routing depth of ‘n’ is defined as the upper network node of a network node having the routing depth of ‘n+1’. Moreover, the network node having the routing depth of ‘n+1’ is defined as the lower network node of the network node having the routing depth of ‘n’.

In the sensor network 10, the link costs between network nodes (i.e., the first and second sensor nodes 1 and 2) having the routing depth of ‘1’ and the sink node S are determined. Exemplarily, link cost represents the quality of a communication channel between two network nodes.

Exemplarily, link cost may be determined based on the strength of a radio frequency (RF) signal between two network nodes.

Exemplarily, link cost may be determined based on a control packet and a response packet for a predetermined time. For example, a specific network node may determine link cost with a counterpart network node, based on a control packet and a response packet that have been received for recent one minute. For example, a specific network node may determine the link cost with a counterpart network node, based on a control packet that has been transmitted for recent ten minutes and a response packet that has been received for recent ten minutes.

For example, each of the first and second sensor nodes 1 and 2 transmits a control packet to the sink node S. In response to the transmitted control packet, the sink node S transmits a response packet to the first and second sensor nodes 1 and 2. The first link costs between first and second sensor nodes 1 and 2 and the sink node S may be determined, based on the reception rate of a response packet in accordance with the transmitted control packet and the reception delay time of the response packet in accordance with the transmitted control packet.

Likewise, the sink node S transmits control packets to the first and second sensor nodes 1 and 2, respectively. In response to the transmitted control packet, each of the first and second sensor nodes 1 and 2 transmits a response packet to the sink node S. Based on a control packet and a response packet, the second link costs between the sink node S and the first and second sensor nodes 1 and 2 are determined.

Exemplarily, when the first link costs are determined, a control packet is transmitted from lower network nodes (for example, the first and second sensor nodes 1 and 2) to an upper network node (for example, the sink node S). Accordingly, the first link cost is called uplink cost ‘Cu’. When the second link costs are determined, a control packet is transmitted from an upper network node (for example, the sink node S) to lower network nodes (for example, the first and second sensor nodes 1 and 2). Accordingly, the second link cost is called downlink cost ‘Cd’.

Likewise with that the link costs between the sink node S and the first and second sensor nodes 1 and 2 are determined, the link costs between the first and second sensor nodes 1 and 2 and the third sensor node 3 are determined. That is, in the sensor network 10, the link costs (for example, uplink costs ‘Cu’ and downlink costs ‘Cd’ between upper network nodes and lower network nodes are determined.

In FIG. 1, the uplink cost ‘Cu’ and downlink cost ‘Cd’ between the sink node S and the first sensor node 1 are illustrated as being 40, respectively. The uplink cost ‘Cu’ and downlink cost ‘Cd’ between the first and third sensor nodes 1 and 3 are illustrated as being 20 and 80, respectively. The uplink cost ‘Cu’ and downlink cost ‘Cd’ between the second and third sensor nodes 2 and 3 are illustrated as being 80 and 20, respectively.

In the sensor network 10, moreover, the transmission/reception rate between upper network nodes and lower network nodes are determined. For example, a transmission/reception rate is determined based on the amount of a packet that the third sensor node 3 transmits to the first sensor node 1 or the second sensor node 2 and the amount of a packet that the third sensor node 3 receives from the first sensor node 1 or the second sensor node 2. That is, the transmission/reception rate of a specific network node is determined based on transmission amount that the specific network node transmits to an upper network node and reception amount that the specific network node receives from the upper network node.

Based on the determined link costs and transmission/reception rate, the specific network node calculates a weighted link cost for the upper network nodes. For example, by using the determined link costs as weight values, the specific network node calculates a weighted link cost for the upper network nodes. Based on the weighted link cost, the specific network node selects a parent node from among the upper network nodes.

Exemplarily, it is assumed that the third sensor node 3 selects the parent node from among the first and second sensor nodes 1 and 2 (i.e., the upper network nodes). The third sensor node 3 determines the link costs with the first and second sensor nodes 1 and 2 (i.e., the upper network nodes), respectively. The third sensor node 3 receives the link costs between the first and second sensor nodes 1 and 2 (i.e., the upper network nodes) and the sink node S from the first and second sensor nodes 1 and 2 (i.e., the upper network nodes), respectively. Furthermore, the third sensor node 3 determines a transmission/reception rate for the first and second sensor nodes 1 and 2 (i.e., the upper network nodes). Exemplarily, it is assumed that a transmission rate is 10 and a reception rate is 1.

Weighted uplink costs are calculated based on a transmission rate and uplink costs ‘Cu’. First, it is assumed that a weighted uplink cost for the first sensor node 1 is calculated. The uplink cost ‘Cu’ between the third sensor node 3 and the first sensor node 1 is 20. When a transmission rate of 10 is weighted (for example, multiplied) to the uplink cost ‘Cu’ of 20 between the third sensor node 3 and the first sensor node 1, 200 is calculated. When the uplink cost ‘Cu’ of 40 between the first sensor node 1 and the sink node S is added to a calculated value, 240 is calculated. That is, the weighted uplink cost for the first sensor node 1 of the third sensor node 3 is calculated as being 240.

It is assumed that a weighted uplink cost for the second sensor node 2 is calculated. The uplink cost ‘Cu’ between the third sensor node 3 and the second sensor node 2 is 80. When a transmission rate of 10 is weighted (for example, multiplied) to the uplink cost ‘Cu’ of 80 between the third sensor node 3 and the second sensor node 2, 800 is calculated. When the uplink cost ‘Cu’ of 40 between the second sensor node 2 and the sink node S is added to a calculated value, 840 is calculated. That is, the weighted uplink cost for the second sensor node 2 of the third sensor node 3 is calculated as being 840.

Likewise, weighted downlink costs are calculated based on a reception rate and link costs. The weighted downlink cost for the first sensor node 1 of the third sensor node 3 is 120. The weighted downlink cost for the second sensor node 1 of the third sensor node 3 is 60.

Based on a weighted uplink cost and a weighted downlink cost, a weighted link cost is calculated. Exemplarily, the weighted link cost is calculated in accordance with the average (for example, arithmetic average) of the weighted uplink cost and the weighted downlink cost.

The weighted uplink cost for the first sensor node 1 of the third sensor node 3 is 240, and a weighted downlink cost is 120. Therefore, the weighted link cost for the first sensor node 1 of the third sensor node 3 is 180. The weighted uplink cost for the second sensor node 2 of the third sensor node 3 is 840, and a weighted downlink cost is 60. Accordingly, the weighted link cost for the second sensor node 2 of the third sensor node 3 is 450.

A weighted link cost for the second sensor node 2 is 450 and is greater than a weighted link cost of 180 for the first sensor node 1. Accordingly, the third sensor node 3 selects the second sensor node as a parent node.

In the sensor network 10, as described above, the parent node is selected based on a link cost and a transmission/reception rate. Therefore, the optimal parent node with consideration of a packet transmission rate may be selected.

Exemplarily, a specific network node may receive the weighted link costs for the sink node S of upper network nodes from the upper network nodes. Weighted link costs for the upper network nodes are calculated based on weighted link costs that are received, link costs with the upper network nodes and a transmission/reception rate. That is, the weighted link costs of links that are connected from a specific network node to the sink node S through the upper network nodes are determined.

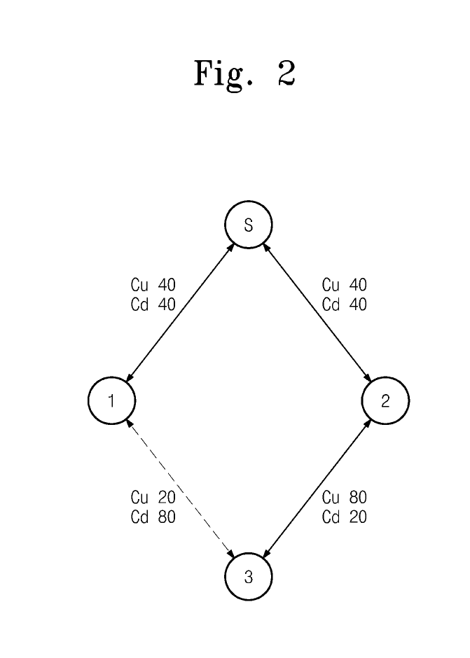

FIG. 2 is a block diagram illustrating the channel connection state of the sensor network 10 in FIG. 1.

Referring to FIG. 2, each of the first and second network nodes 1 and 2 selected the sink node S as a parent node. As described above with reference to FIG. 1, the third sensor node 3 selects the second sensor node 2 as a parent node.

Exemplarily, link costs and a transmission/reception rate may be changed depending on communication environment. When the link costs and the transmission/reception rate are changed, each of the network nodes of the sensor network 10 may update a parent node.

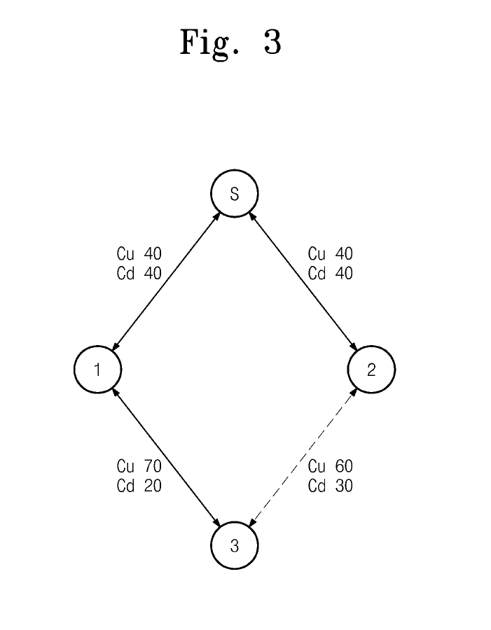

FIG. 3 is a block diagram illustrating an embodiment of the present invention in which the network environment of the sensor network 10 in FIG. 1 has been changed.

Referring to FIG. 3, the uplink cost ‘Cu’ and downlink cost ‘Cd’ between the first and third sensor nodes 1 and 3 are illustrated as being 70 and 20, respectively. The uplink cost ‘Cu’ and downlink cost ‘Cd’ between the second and third sensor nodes 2 and 3 are illustrated as being 60 and 30, respectively.

Furthermore, it is assumed that the transmission rate and reception rate of the third sensor node 3 is 6 and 4, respectively.

The weighted link cost for the first sensor node 1 of the third sensor node 3 is calculated as being 290. The weighted link cost for the second sensor node 2 of the third sensor node 3 is calculated as being 280. Since the weighted link cost for the first sensor node 1 of the third sensor node 3 is higher than the weighted link cost for the second sensor node 2, the third sensor node 3 updates a parent node to the first sensor node 1.

Exemplarily, a transmission/reception rate may be determined based on the transmission/reception amount of a packet that is transmitted/received for a predetermined time. For example, a specific sensor node may determine a transmission/reception rate based on the transmission/reception amount of a packet that is transmitted/received for recent one minute. For example, a specific sensor node may determine a transmission/reception rate based on the transmission/reception amount of a packet that is transmitted/received for recent ten minutes.

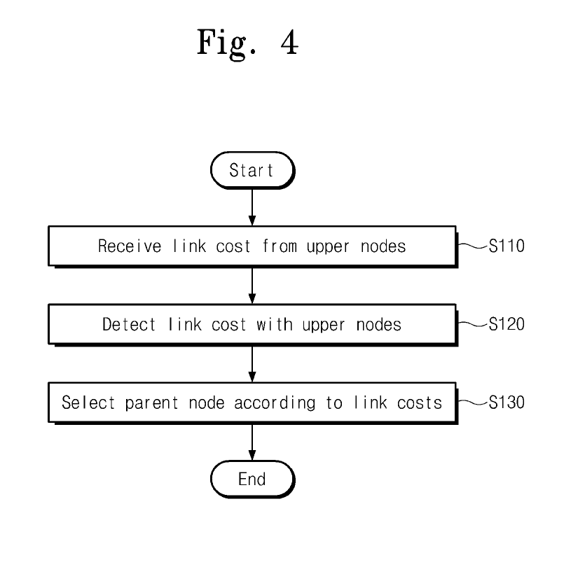

FIG. 4 is a flow chart for describing an operating method of the sensor network 10 which has been described above with reference to FIGS. 1 through 3.

Referring to FIGS. 1 through 4, link costs are received from the upper network nodes in operation S110. For example, a specific network node (for example, the third sensor node 3) may detect upper network nodes (for example, the first and second sensor nodes 1 and 2) that exist within a communication range. The link costs may be transmitted from the detected upper network nodes (for example, the first and second sensor nodes 1 and 2).

Exemplarily, as described above with reference to FIGS. 1 through 3, an uplink cost ‘Cu’ of 40 and a downlink cost ‘Cd’ of 40 may be transmitted from the first sensor node 1 to the third sensor node 3. Furthermore, an uplink cost ‘Cu’ of 40 and a downlink cost ‘Cd’ of 40 may be transmitted from the second sensor node 2 to the third sensor node 3.

Exemplarily, the link costs (for example, the uplink cost ‘Cu’ and the downlink cost ‘Cd’), which are respectively received from the detected upper network nodes (for example, the first and second sensor nodes 1 and 2), represent the link costs between the detected upper network nodes (for example, the first and second sensor nodes 1 and 2) and the sink node S, respectively. For example, the link costs, which are respectively received from the detected upper network nodes (for example, the first and second sensor nodes 1 and 2), represent the weighted link costs (for example, a weighted uplink cost and a weighted downlink cost) between the detected upper network nodes (for example, the first and second sensor nodes 1 and 2) and the sink node S, respectively.

The link costs with the upper network nodes are detected in operation S120. A specific network node (for example, the third sensor node 3) detects link costs with the detected upper network nodes (for example, the first and second sensor nodes 1 and 2).

Exemplarily, as described above with reference to FIGS. 1 and 2, an uplink cost ‘Cu’ of 20 and a downlink cost ‘Cd’ of 80 are detected between the first sensor node 1 and the third sensor node 3. An uplink cost ‘Cu’ of 80 and a downlink cost ‘Cd’ of 20 are detected between the second sensor node 2 and the third sensor node 3.

A parent node is selected according to link costs in operation S130. For example, one of the detected upper network nodes (for example, the first and second sensor nodes 1 and 2) is selected as the parent node of the specific network node (for example, the third sensor node 3), based on link costs that are received from the detected upper network nodes (for example, the first and second sensor nodes 1 and 2) and the link costs that are detected in operation S120.

Exemplarily, as described above with reference to FIGS. 1 through 3, an upper network node corresponding to the highest-weighted link cost among the detected upper network nodes is selected as a parent node.

In the sensor network 10, as described above, a weighted link cost is calculated based on a link cost and a transmission/reception rate. Based on the weighted link cost, the parent node of a specific network node is selected. Accordingly, the optimal parent node with consideration of the link cost and the transmission/reception rate can be selected, and the real-time supporting ability of the sensor network 10 can be enhanced.

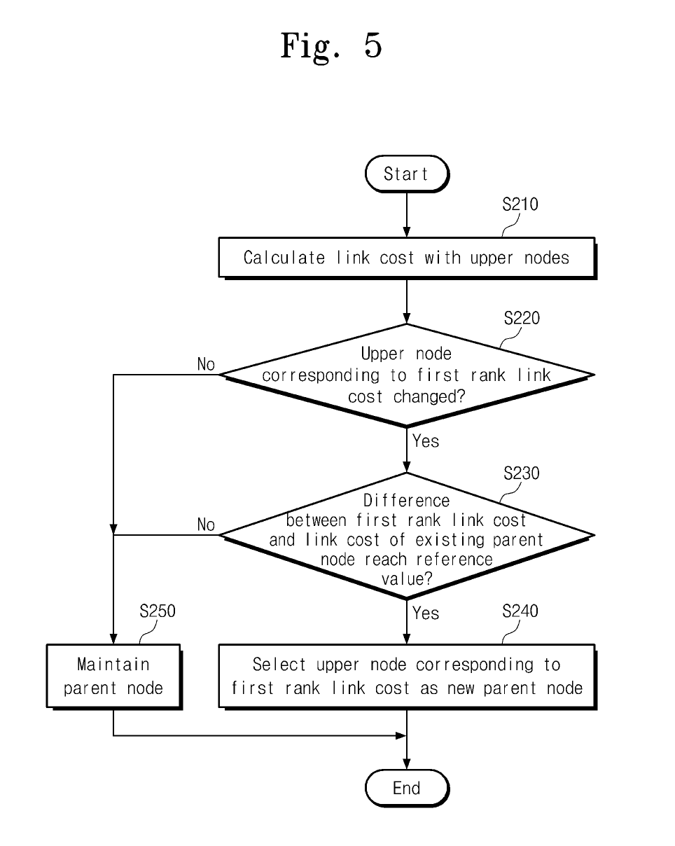

FIG. 5 is a flow chart for describing a parent node updating operation of the sensor network 10 which has been described above with reference to FIGS. 1 through 3.

Referring to FIGS. 1 through 3 and 5, the link costs (for example, weighted link costs) for upper network nodes of a specific network node are calculated in operation S210. For example, operation S210 may be performed, likewise with operations S110 and S120 that have been described above with reference to FIG. 4.

Whether an upper network node corresponding to a first rank link cost (for example, weighted link cost) among the calculated link costs is changed is determined in operation S220. Exemplarily, the ranks of the link costs (for example, weighted link costs) are set based on communication quality corresponding to link costs (for example, weighted link costs). For example, when communication quality corresponding to a first link cost (for example, weighted link cost) is higher than communication quality corresponding to a second link cost (for example, weighted link cost), the rank of the first link cost (for example, the weighted link cost) is higher than the rank of the second link cost (for example, the weighed link cost). Exemplarily, as described above with reference to FIGS. 1 through 3, a upper network node having the highest link cost (for example, weighted link cost) among upper network nodes may be set as a first rank upper network node.

When the upper network node corresponding to the first rank link cost (for example, weighted link cost) is not changed, the existing parent node is maintained in operation S250. When the upper network node corresponding to the first rank link cost (for example, weighted link cost) is changed, operation S230 is performed.

Whether difference between a new first rank link cost (for example, weighted link cost) and the link cost (for example, weighted link cost) of the existing parent node reaches a reference value is determined. When the difference between the new first rank link cost (for example, weighted link cost) and the link cost (for example, weighted link cost) of the existing parent node does not reach the reference value, the existing parent node is maintained in operation S250. When the difference between the new first rank link cost (for example, weighted link cost) and the link cost (for example, weighted link cost) of the existing parent node reaches the reference value, operation S240 is performed.

An upper network node corresponding to the new first rank link cost (for example, weighted link cost) is selected as a new parent node in operation S240.

The parent node updating operation that has been described above with reference to FIG. 5 is repeatedly performed. For example, the parent node updating operation is continuously performed. For example, the parent node updating operation is performed at periods of a predetermined time. For example, the parent node updating operation is performed when a specific condition is satisfied. For example, the parent node updating operation is arbitrarily performed.

In the sensor network 10, therefore, a link cost and a transmission/reception rate is repetitively updated, and a weighted link cost is repeatedly updated. Based on the weighted link cost that is repetitively updated, a parent node is selected. That is, the parent node is adaptively selected. Accordingly, even when communication environment is changed, the optimal parent node can be selected.

Moreover, when the difference between the new first rank link cost (for example, weighted link cost) and the link cost (for example, weighted link cost) of the existing parent node is less than the reference value, the existing parent node is maintained. Accordingly, in consideration of the change amounts of an overhead and a link cost (for example, weighted link cost) dependent on the change of a parent node, whether to change the parent node may be selected.

Exemplarily, operation S230 may be omitted. That is, when an upper network node corresponding to a first rank link cost (for example, weighted link cost) is changed, an upper network node corresponding to a new first rank link cost (for example, weighted link cost) may be selected as a parent node.

The parent node updating operation is not limited to be performed between the first and third sensor nodes 1 and 3. The parent node updating operation may be performed between the specific network node and upper network nodes of the sensor network 10.

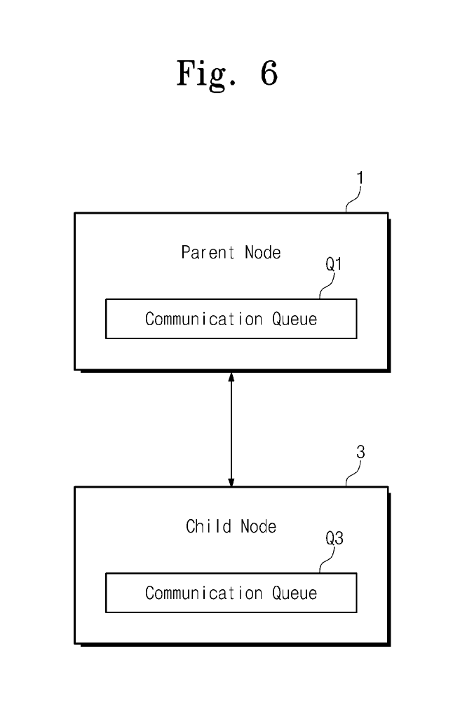

FIG. 6 is a block diagram illustrating the first and third sensor nodes 1 and 3 of the sensor network 10 in FIG. 1.

Referring to FIGS. 1 and 6, the third sensor node 3 maintains the first sensor node 1 as a parent node.

The first and third sensor nodes 1 and 3 include communication queues Q1 and Q3, respectively. The communication queue Q1 of the first sensor node 1 stores a transmission packet to be transmitted from the first sensor node 1. The communication queue Q3 of the third sensor node 3 stores a transmission packet to be transmitted from the third sensor node 3. Likewise, each of the network nodes of the sensor network 10 includes a communication queue for storing a transmission packet.

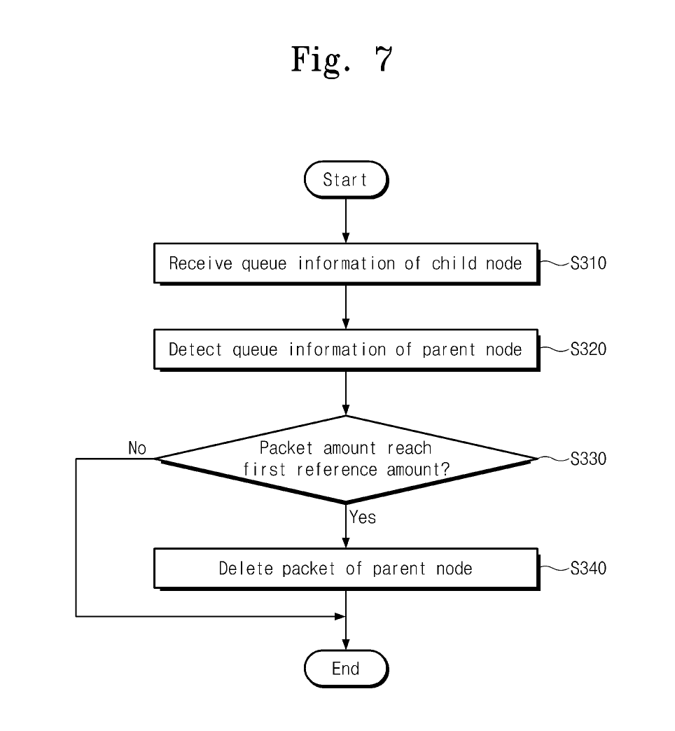

FIG. 7 is a flow chart for describing a packet amount managing operation of the first and third sensor nodes 1 and 3 in FIG. 6.

Referring to FIGS. 6 and 7, the queue information of a child node is received in operation S310. That is, the queue information of the third sensor node 3 is transmitted to the first sensor node 1. Exemplarily, transmitted queue information may include a transmission packet amount that is stored in the queue Q3 of a child node (for example, the third sensor node 3).

The queue information of a parent node is detected in operation S320. That is, the queue information of the first sensor node 1 is detected. Exemplarily, a transmission packet amount that is stored in the queue Q1 of a parent node (i.e., the first sensor node 1) may be detected.

Whether a packet amount reaches a first reference amount is determined in operation S330. For example, whether the total sum of the transmission packet amount of a child node (for example, the third sensor node 3) and the transmission packet amount of a parent node (for example, the first sensor node 1) reaches the first reference amount may be determined. That is, it can be understood that a total packet amount to be transmitted from the parent node (for example, the first sensor node 1) is determined.

It can be understood that the total packet amount to be transmitted from the parent node (for example, the first sensor node 1) represents the congestion of the parent node (for example, the first sensor node 1). Comparing the total packet amount to be transmitted from the parent node (for example, the first sensor node 1) and the first reference amount can be understood as determining the congestion of the parent node (for example, the first sensor node 1).

Guaranteed delay denotes a delay time that is allowed until a specific transmission packet is transferred to the sink node S. When the parent node (for example, the first sensor node 1) is in a congestion state, guaranteed delay may be exceeded in at least one of total packets to be transmitted from the parent node (for example, the first sensor node 1). That is, when the total packet amount to be transmitted from the parent node (for example, the first sensor node 1) is more than the first reference amount, guaranteed delay may be exceeded in at least one of total packets to be transmitted from the parent node (for example, the first sensor node 1).

Accordingly, when a packet amount reaches the first reference amount in operation S330, operation S340 is performed. The packet of the parent node (for example, the first sensor node 1) is deleted in operation S340.

Exemplarily, packets, in which guaranteed delay is exceeded among transmission packets that are stored in the queue Q1 of the parent node (for example, the first sensor node 1), may be deleted. For example, the guaranteed delay of a specific packet may be preset in the head of the specific packet.

For example, packets (for example, packets having low priority among packets), having relatively low priority among transmission packets that are stored in the queue Q1 of the parent node (for example, the first sensor node 1), may be deleted. Exemplarily, the priority of the specific packet may be preset in the head of a packet. For example, the priority of a specific packet may be set based on the importance or real-time requirement of the specific packet.

For example, like a packet for indicating disasters such as typhoon and flood, a packet for indicating accidents such as traffic accidents and firing and a packet for indicating the invasion of the border, the priority of a packet for representing the rapid change of a sensing result may be highly set. Like a packet indicating temperature and a packet indicating the direction of wind, the priority of a packet for representing the slow change of a sensing result may be low set.

When the transmission packet of the parent node (for example, the first sensor node 1) is deleted, the congestion of the parent node (for example, the first sensor node 1), i.e., a total packet amount to be transmitted from the parent node (for example, the first sensor node 1) decreases. Accordingly, the real-time supporting ability of the parent node (for example, the first sensor node 1) is improved.

The packet amount managing operation that has been described above with reference to FIG. 7 is repetitively performed. Accordingly, the real-time supporting ability of the parent node (for example, the first sensor node 1) can be guaranteed. For example, the packet amount managing operation is continuously performed. For example, the packet amount managing operation is performed at periods of a predetermined time. For example, the packet amount managing operation is performed when a specific condition is satisfied. For example, when the transmission packet amount of the child node (for example, the third sensor node 3) reaches a predetermined amount, the child node (for example, the third sensor node 3) may transmit the transmission packet amount to the parent node (for example, the first sensor node 1). For example, the packet amount managing operation is arbitrarily performed.

The packet amount managing operation is not limited to be performed between the first and third sensor nodes 1 and 3. The packet amount managing operation may be performed between the specific network node of the sensor network 10 and the parent node of the specific network node.

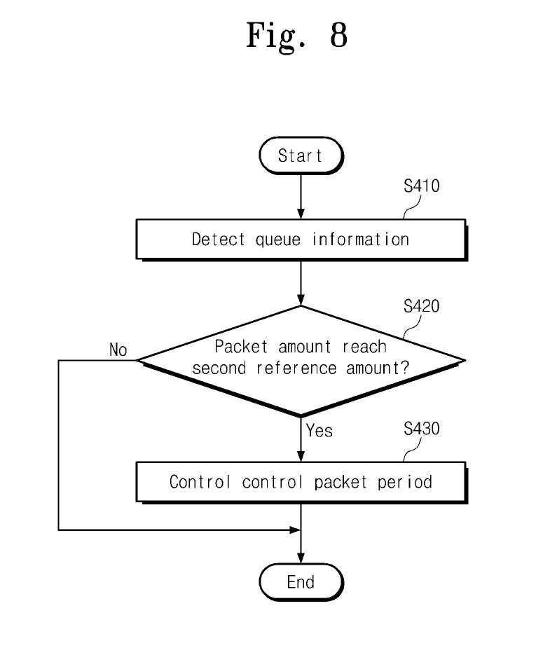

FIG. 8 is a flow chart for describing a control packet managing operation of the first and third sensor nodes 1 and 3 in FIG. 6.

Referring to FIGS. 6 and 8, a specific network node (for example, the third sensor node 3) detects queue information in operation S410. For example, the specific network node (for example, the third sensor node 3) detects the packet amount of the communication queue Q3.

Whether a packet amount reaches a second reference amount is determined in operation S420. When the packet amount reaches the second reference amount, a control packet period is controlled in operation S430. A control packet includes a hello message for determining a link cost and a response message to it. The control packet includes packets for maintaining and managing the sensor network 10, and is periodically exchanged between the specific network node (for example, the third sensor node 3) and its upper or lower network node.

Exemplarily, when the packet amount increases and thereby reaches the second reference amount, it can be understood that the congestion of the specific network node (for example, the third sensor node 3) increases. At this point, the specific network node (for example, the third sensor node 3) increases the control packet period. When the control packet period increases, a packet amount to be transmitted from the specific network node (for example, the third sensor node 3) decreases. Therefore, the congestion of the specific network node (for example, the third sensor node 3) decreases. Accordingly, the real-time supporting ability of the specific network node (for example, the third sensor node 3) is enhanced.

Exemplarily, when the packet amount decreases and thereby reaches the second reference amount, it can be understood that the congestion of the specific network node (for example, the third sensor node 3) decreases. At this point, the specific network node (for example, the third sensor node 3) increases the control packet period. When the control packet period increases, the performing frequency of an operation (such as determining a link cost) for maintaining and managing the sensor network 10 increases. Accordingly, the maintaining and managing ability of the sensor network 10 is improved.

As described above, the control packet period is controlled, based on the packet amount of the communication queue Q3 of the specific network node (for example, the third sensor node 3). That is, the resource of the specific network node (for example, the third sensor node 3), which is allocated to the maintenance and management of the sensor network 10 and real-time support, based on a transmission packet amount. Accordingly, the maintaining and managing ability and real-time supporting ability of the sensor network 10 can be optimized.

The control packet managing operation that has been described above with reference to FIG. 8 is repeatedly performed. Therefore, the maintaining and managing ability and real-time supporting ability of the specific network node (for example, the third sensor node 3) can be guaranteed. For example, the control packet managing operation is continuously performed. For example, the control packet managing operation is performed at periods of a predetermined time. For example, the control packet managing operation is performed when a specific condition is satisfied. For example, when the packet amount of the specific network node (for example, the third sensor node 3) reaches a predetermined amount, the specific network node (for example, the third sensor node 3) may perform the control packet managing operation. For example, the control packet managing operation is arbitrarily performed.

The control packet managing operation that has been described above with reference to FIG. 8 is not limited to be performed in the third sensor node 3. The control packet managing operation may be performed in each of the network nodes of the sensor network 10.

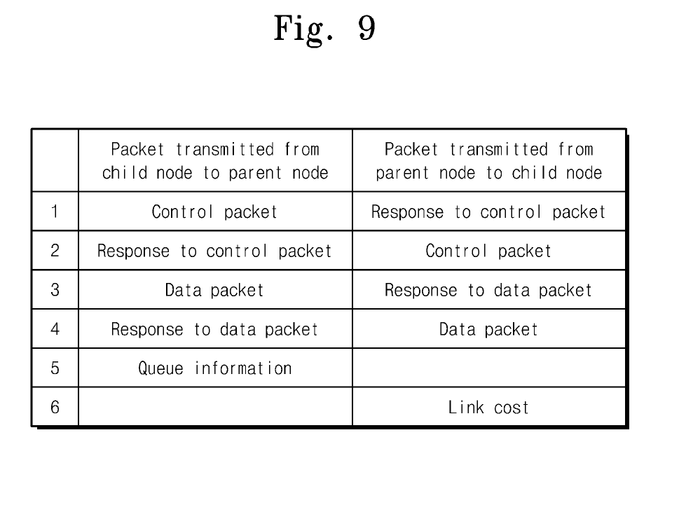

FIG. 9 is a table showing packets which are exchanged between the parent node and child node of the sensor network 10 in FIG. 1.

Referring to FIG. 9, packets that are transmitted from the child node to the parent node includes a control packet, response to the control packet, a data packet, response to the data packet, and queue information. Packets that are transmitted from the parent node to the child node include response to a control packet, a control packet, response to the data packet, a data packet and a link cost.

Two or more packets among packets transmitted between the child node and the parent node may be combined into one packet. That is, the packets transmitted between the child node and the parent node may be piggybacked.

For example, two or more packets that are transmitted from the child node to the parent node may be combined into one packet. For example, the child node may combine the control packet and the data packet into one packet to transmit the combined packet to the parent node. The child node may combine response to the control packet and the data packet into one packet to transmit the combined packet to the parent node.

Likewise, two or more packets that are transmitted from the parent node to the child node may be combined into one packet. For example, the parent node may combine the control packet and the link cost into one packet to transmit the combined packet to the child node. The parent node may combine response to the data packet and the link cost into one packet to transmit the combined packet to the child node.

When two or more packets are combined into one packet and thereby transmitted, an overhead for processing a packet is reduced. Accordingly, the real-time supporting ability of the sensor network 10 is enhanced.

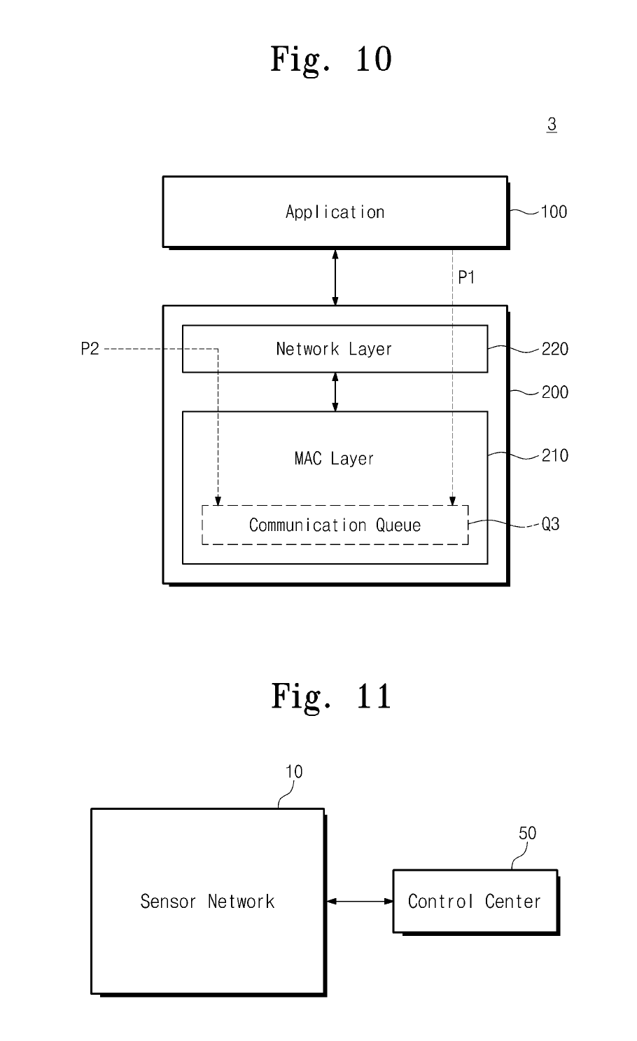

FIG. 10 is a block diagram illustrating the third sensor node 3 in FIG. 1.

Referring to FIG. 10, the third sensor node 3 includes an application 100 and an operating system (OS) 200. The application 100 performs a sensing operation and a communicating operation by using the resources of the third sensor node 3. The OS 200 provides a means in which the application 100 may control the resources of the third sensor node 3. For example, the OS 200 includes at least one of TinyOS, MANTIS, PEEROS, T-Engine, and NanoQplus.

The OS 200 includes a Media Access Control (MAC) layer 210 and a network layer 220. The MAC layer 210 supports communication between the network nodes of the sensor network 10. The network layer 220 generates, determines and controls a path through which a packet is transmitted via the network nodes of the sensor network 10.

The transmission packet of the third sensor node 3 includes a generation packet P1 and a tandem packet P2. The generation packet P1 is one that is generated in the third sensor node 3. For example, the generation packet P1 includes a packet for representing the sensing result of the third sensor node 3, and a control packet that is generated in the third sensor node 3. Exemplarily, the generation packet P1 is generated in the application 100 and is transferred to the network layer 220.

The tandem packet P2 represents one that is transmitted from another network node through the third sensor node 3. In FIG. 10, for briefness, it is illustrated that the tandem packet P2 is directly transferred to the network layer 220. However, the tandem packet P2 may be received in the MAC layer 210 and transferred to the network layer 220.

When transmission packets P1 and P2 are transferred, the network layer 220 notifies the MAC layer 210 of that the transmission packet has been transferred. For example, the network layer 220 may execute a call-back function.

In response to the call of the network layer 220, the MAC layer 210 manages the priority of the communication queue Q3 and transmission packets P1 and P2. For example, the MAC layer 210 receives the transmission packets P1 and P2 from the network layer 220. The MAC layer 210 compares the priority of the received transmission packets P1 and P2 with the priorities of packets that are stored in the communication queue Q3. Based on the comparison result, the MAC layer 210 determines the transmission order of the received transmission packets P1 and P2. The received transmission packets P1 and P2 are stored in the communication queue Q3 in the determined transmission order.

The network layer 220 does not provide a communication queue. When the transmission packets P1 and P2 are generated, the network layer 220 calls the MAC layer 210. When the transmission packets P1 and P2 are generated, the network layer 220 does not manage priority and communication queues. A priority managing function and a communication queue managing function are concentrated on the MAC layer 210 that provides the communication queue Q3. Since a repetitive function is not performed in the network layer 220 and the MAC layer 210, a transmission packet managing time decreases. Accordingly, the real-time supporting ability of the third sensor node 3 is improved.

The queue managing operation that has been described above with reference to FIG. 10 is not limited to be performed in the third sensor node 3. The queue managing operation may be performed in each of the network nodes of the sensor network 10.

FIG. 11 is a diagram illustrating an embodiment of a sensor system which includes the sensor network 10 in FIG. 1.

Referring to FIG. 11, a sensor system according to an embodiment of the present invention includes a sensor network 10 and a control center 50. As described above with reference to FIGS. 1 through 10, the sensor network 10 provides an enhanced real-time supporting ability. For example, in the sensor network 10, a parent node is selected and updated according to a link cost and a transmission/reception rate. In the sensor network 10, a portion of transmission packets is deleted based on a packet transmission amount, and a control packet period is controlled based on the packet transmission amount. Two or more packets among the transmission packets may be combined and thereby form one packet. Furthermore, a queue managing function and a priority managing function are not provided to the network layer 220, and may be provided to the MAC layer 210.

The control center 50 collects a sensing result from the sensor network 10. For example, based on the sensing result that is collected from the senor network 10, the control center 50 may detect in real time an area corresponding to the sensor network 10. For example, based on the sensing result that is collected from the senor network 10, the control center 50 may detect whether events such as crimes, disasters, accidents and border disputes occur in the area corresponding to the sensor network 10. For example, based on the sensing result collected from the sensor network 10, the control center 50 may acquire information such as the weather, parking and lighting control circumstances of the area corresponding to the sensor network 10.

Exemplarily, two or more sensor networks may be connected to the control center 50. The control center 50 may detect in real time areas corresponding to the two or more sensor networks.

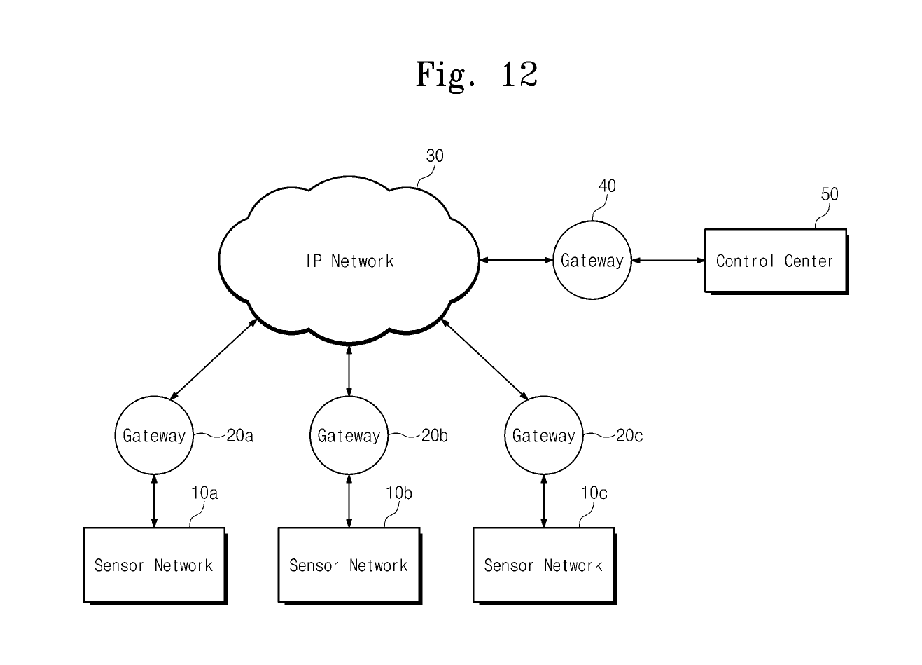

FIG. 12 is a diagram illustrating another embodiment of a sensor system including the sensor network 10 in FIG. 1.

Referring to FIG. 12, a sensor system according to another embodiment of the present invention includes sensor networks 10a to 10c, gateways 20a to 20c and 40, an Internet Protocol (IP) network 30, and a control center 50.

Each of the sensor networks 10a to 10c operates, as described above with reference to the described in FIGS. 1 through 10. The sensor networks 10a to 10c are connected to the gateways 20a to 20c corresponding to them, respectively. The sensor networks 10a to 10c are connected to the IP network 30 through the gateways 20a to 20c, the sensor, respectively. The control center 50 is also connected to the IP network 30 through the gateway 40.

The control center 50 collects sensing results from the sensor networks 10a to 10c. For example, the sensing results of the sensor networks 10a to 10c may be transferred to the IP network 30 through the gateways 20a to 20c corresponding to them. The sensing results may be transferred from the IP network 30 to the gateway 40 that is connected to the control center 50. Furthermore, the control center 50 receives the sensing results of the sensor networks 10a to 10c from the gateway 40.

Based on the sensing results collected from the sensor networks 10a to 10c, the control center 50 detects areas corresponding to the sensor networks 10a to 10c. For example, based on the sensing results collected from the sensor networks 10a to 10c, the control center 50 may detect whether events such as crimes, disasters, accidents and border disputes occur in the areas corresponding to the sensor networks 10a to 10c. For example, based on the sensing results collected from the sensor networks 10a to 10c, the control center 50 may acquire information such as the weather, parking and lighting control circumstances of the areas corresponding to the sensor networks 10a to 10c.

The sensor networks 10a to 10c are connected to the IP network 30, and thus the control center 50 can perform wide-area detection based on the sensor networks 10a to 10c. For example, the control center 50 may detect in real time areas corresponding to eup, myeon, dong, gu, gun, si, do or nation units.

Exemplarily, the sensor networks 10a to 10c are connected to the IP network 30 through a satellite. When the sensor networks 10a to 10c are connected to the IP network 30 through the satellite, it can be understood that isolation areas such as islands, mountains, branch offices in foreign countries and diplomatic offices in foreign countries may be detected.

According to embodiments of the present invention, the parent node is selected and updated according to the link cost and a transmission/reception rate. Accordingly, information can be transmitted in real time.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An operating method of sensor network, the operating method comprising:
detecting upper network nodes of a specific network node;
detecting link costs between the specific network node and the detected upper network nodes, respectively;
detecting a transmission and reception rate for the detected upper network nodes of the specific network node; and
selecting one of the detected upper network nodes as a parent node of the specific network node, based on the detected link costs and the detected transmission and reception rate.

2. The operating method of claim 1, wherein the selecting of one of the detected upper network nodes comprises calculating weighted link costs from the detected link costs by using the detected transmission and reception rate as a weight value,
wherein one of the detected upper network nodes is selected as the parent node of the specific network node, based on the weighted link costs.

3. The operating method of claim 2, further comprising transmitting link costs between the detected upper network nodes and a sink node to the specific network node,
wherein one of the detected upper network nodes is selected as the parent node of the specific network node, based on the weighted link costs, the detected transmission and reception rate and the transmitted link costs.

4. The operating method of claim 3, wherein the transmitting of link costs comprises transmitting weighted link costs between the detected upper network nodes and the sink node to the specific network node.

5. The operating method of claim 2, wherein a network node having a highest weighted link cost among the detected upper network nodes is selected as a parent node.

6. The operating method of claim 1, further comprising detecting a transmission packet amount of the selected parent node when a transmission packet exists in the specific network node,
wherein at least one of transmission packets of the parent node is deleted when the detected transmission packet amount is less than a first reference amount.

7. The operating method of claim 6, wherein the detecting of a transmission packet amount comprises detecting a transmission packet amount of the specific network node and a transmission packet amount of the selected parent node,
wherein at least one of the transmission packets of the parent node is deleted when the transmission packet amount of the specific network node and the transmission packet amount of the selected parent node are greater than the first reference amount.

8. The operating method of claim 6, wherein the at least one deleted transmission packet comprises a low rank transmission packet or a transmission packet in which guaranteed delay is exceeded.

9. The operating method of claim 1, further comprising detecting a transmission packet amount of the selected parent node when a transmission packet exists in the selected parent node,
wherein a transmission period of a control packet, which is transmitted from the selected parent node, is controlled based on a comparison result of the detected transmission packet amount and a second reference amount.

10. The operating method of claim 9, wherein the transmission period of the control packet increases when the detected packet amount is more than the second reference amount.

11. The operating method of claim 9, wherein the transmission period of the control packet decreases when the detected packet amount is less than the second reference amount.

12. An operating method of network node of sensor network, the operating method comprising:
detecting upper network nodes;
detecting link costs for the detected upper network nodes, respectively;
detecting a transmission and reception rate for the detected upper network nodes; and
selecting one of the detected upper network nodes as a parent node, based on the detected link costs and the detected transmission and reception rate.

13. The operating method of claim 12, wherein the selecting of one of the detected upper network nodes comprises:
calculating weighted link costs from the detected link costs by using the detected transmission and reception rate as a weight value; and
selecting one of the detected upper network nodes as a parent node, based on the weighted link costs.

14. The operating method of claim 13, wherein the selected parent node is updated when the weighted link costs of the detected upper network nodes are changed.

15. The operating method of claim 12, wherein the network node comprises a first layer controlling communication between network nodes, and a second layer supporting management of a network path through which a packet is transmitted,
wherein:
the first layer comprises a queue storing a transmission packet, and
the operating method further comprises directly transferring a transmission packet to a queue of the first layer when the transmission packet is generated.

16. The operating method of claim 15, wherein the transmission packet is generated when relay transmission of a packet is performed.

17. The operating method of claim 15, further comprising determining a priority of a packet which is transferred to the queue, when the transmission packet is generated, and determining a transmission order of the packet which is transferred to the queue, based on the determined priority.

18. The operating method of claim 12, further comprising determining the transmission packet amount when a transmission packet exists, and increasing a transmission period of a control packet, when the determined transmission packet amount is greater than a reference amount.

19. The operating method of claim 12, further comprising determining the transmission packet amount when a transmission packet exists, and decreasing a transmission period of a control packet, when the determined transmission packet amount is less than a reference amount.

20. The operating method of claim 12, further comprising combining at least two transmission packets into one packet to transmit the combined packet, when transmitting a packet.
